(19) United States
(12) Patent Application Publication
(10) Pub. No.: US 2016/0368066 A1
(43) Pub. Date: Dec. 22, 2016

(54) AIR EXHAUST METHOD OF A PNEUMATIC TOOL AND DEVICES THEREOF

(71) Applicant: Jih I Enterprises Co., Ltd., New Taipei City (TW)

(72) Inventor: Wei-Che HSIAO, New Taipei City (TW)

(21) Appl. No.: 14/826,469

(22) Filed: Aug. 14, 2015

(30) Foreign Application Priority Data
Jun. 18, 2015 (TW) 104119711

(51) Int. Cl. B23B 45/04; B23Q 11/00; B25F 5/00

(52) U.S. Cl. CPC B23B 45/04; B25F 5/00; B23Q 11/005; B23B 2270/30

(57) ABSTRACT

An air exhaust method of a pneumatic tool and devices thereof include a tool body having an air guide element, a brake element sheathed at the air guide element, and an adjustment element fixed at the brake element. The air guide element contains a front and rear air guide structure, and the brake element includes a front and rear movable guiding structure corresponding to the air guide structures. Upon using the pneumatic tool, the front and rear movable guiding structure of the brake element is superimposed to the front and rear air guide structure of the air guide element, discharging air backward to prevent from suspension of dust to facilitate drilling; or the front and rear movable guiding structure escapes from the front and rear air guide structure of the air guide element, discharging debris forward to facilitate cutting, by rotating the adjustment element clockwise or counterclockwise.

### BACKGROUND OF THE INVENTION

### a) Field of the Invention

The present invention relates to an air exhaust method of a pneumatic tool and devices thereof, and more particularly to an air exhaust method of a pneumatic tool and devices thereof, which discharge air backward to prevent from suspension of dust to facilitate drilling or discharge debris forward to facilitate cutting, simply by adjusting the rotation of the pneumatic tool when the pneumatic tool is used.

### b) Description of the Prior Art

For a conventional pneumatic tool, the tool body is provided with a cylinder, a piston and a valve seat set. When the pneumatic tool is used, a fitting is disposed at a front end of the cylinder to constitute the cutting or drilling operation after activating the pneumatic tool. As the cutting operation will form suspension of debris, and the drilling operation will form suspension of dust, the vision of an operator can be interfered and the operation procedure can be affected. Therefore, some pneumatic tools will be provided with an air exhaust device to remove the debris or dust properly that is formed in the operation. Although the shortcoming that the operation is affected by the debris or dust can be improved, the conventional pneumatic tool can only discharge air along a single direction and cannot optionally discharge air forward or backward according to the actual operation requirement, which is not perfect at all. Accordingly, an air exhaust method of a pneumatic tool and devices thereof are invented, so that when the pneumatic tool is used, air can be discharged backward and debris can be discharged forward, thereby facilitating the operation of the pneumatic tool.

### SUMMARY OF THE INVENTION

The primary object of the present invention is to provide an air exhaust method of a pneumatic tool and devices thereof, allowing air to be discharged backward to prevent from suspension of dust to facilitate drilling or allowing debris to be discharged forward to facilitate cutting by simply adjusting the rotation of the pneumatic tool, upon using the pneumatic tool.

The abovementioned air exhaust method of the pneumatic tool and the devices thereof include primarily a tool body which is provided with an air guide element, a brake element sheathed at the air guide element, and an adjustment element fixed at the brake element to drive the brake element to rotate. The air guide element is provided with a front and rear air guide structure, and the brake element is provided with a front and rear movable guiding structure corresponding to the air guide structures. Therefore, when the pneumatic tool is used, the front and rear movable guiding structure of the brake element can be superimposed to the front and rear air guide structure of the air guide element, allowing air to be discharged backward to prevent from suspension of dust to facilitate drilling; or the front and rear movable guiding structure can escape from the front and rear air guide structure of the air guide element, allowing debris to be discharged forward to facilitate cutting, by the clockwise or counterclockwise rotation of the adjustment element.

For the abovementioned air exhaust method of the pneumatic tool and the devices thereof, the front and rear air guide structure of the air guide element is provided with a cutting groove, an inner rim at a front end of the air guide element is provided with rib parts that are arranged at intervals, the movable guiding structures of the brake element are provided with an air guide hole, and an inner rim at a front end of the brake element is provided with shield parts that are arranged at intervals. By the clockwise or counterclockwise rotation of the adjustment element, the air guide hole of the brake element can be superimposed to the cutting groove of the air guide element, and the shield parts can shield the intervals between the rib parts of the air guide element; or the air guide hole of the brake element can escape from the cutting groove of the air guide element and the shield parts can be superimposed to the rib parts of the air guide element.

For the abovementioned air exhaust method of the pneumatic tool and the devices thereof, the brake element is provided with a pillar, and an inner rim of the adjustment element is provided with a slot, allowing the pillar to be latched into the slot, so that when the adjustment element rotates, the brake element can be driven to rotate by the restraint of the pillar and the slot.

For the abovementioned air exhaust method of the pneumatic tool and the devices thereof, an outer rim of the air guide element is provided with positioning ribs, and the tool body is provided with rabbets, such that when the air guide element is fixed at the tool body, the air guide element can be positioned by latching the positioning ribs into the rabbets.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional exploded view of the present invention.

FIG. 2 shows a partial cutaway view of a tool body of the present invention.

FIG. 2A shows a partially enlarged view of FIG. 2.

FIG. 3 shows another three-dimensional exploded view of the present invention.

FIG. 4 shows a partial cutaway view of an adjustment element of the present invention.

FIG. 4B shows a partially enlarged view of FIG. 4.

FIG. 5 and FIG. 6 show state diagrams of shield parts and rib parts when the present invention discharges air forward.

FIG. 7 and FIG. 8 show state diagrams of the shield parts and the rib parts when the present invention discharges air backward.

FIG. 9 shows a state diagram of an air guide hole and a cutting groove when the present invention discharges air forward.

FIG. 10 shows a state diagram of the air guide hole and the cutting groove when the present invention discharges air backward.

### DETAILED DESCRIPTION OF THE PREFERRED EMBODIMENTS

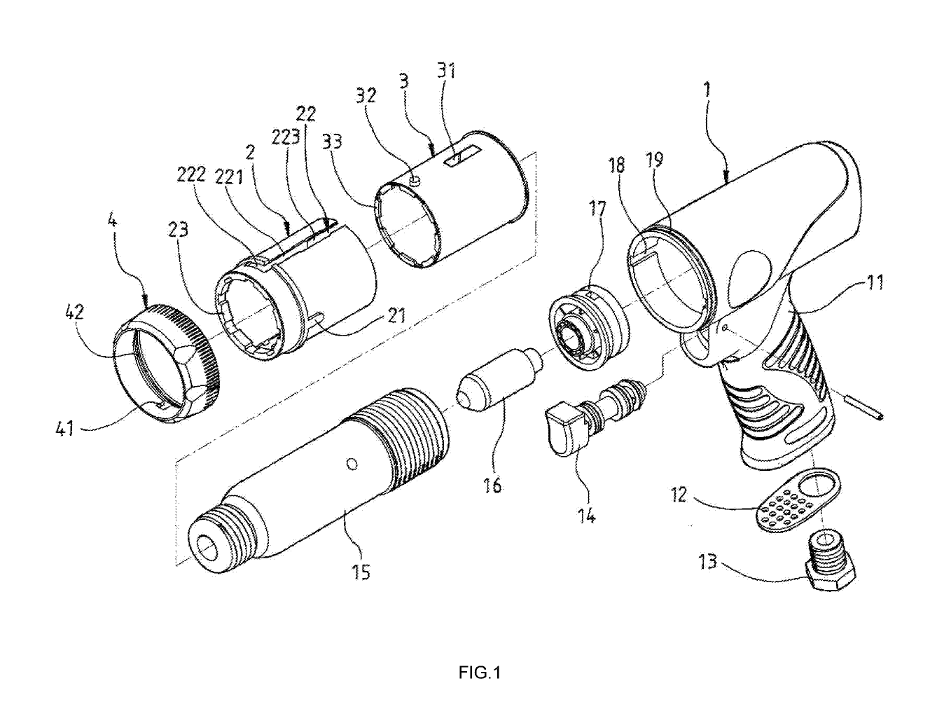

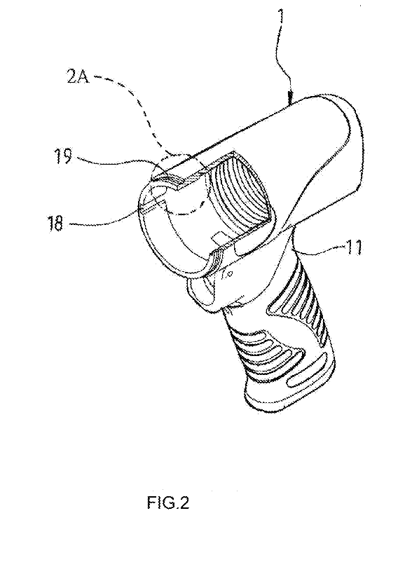

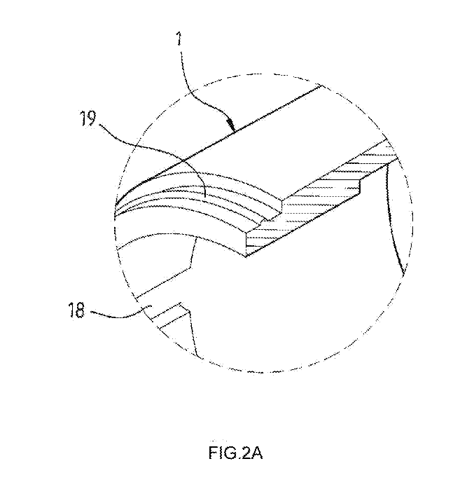

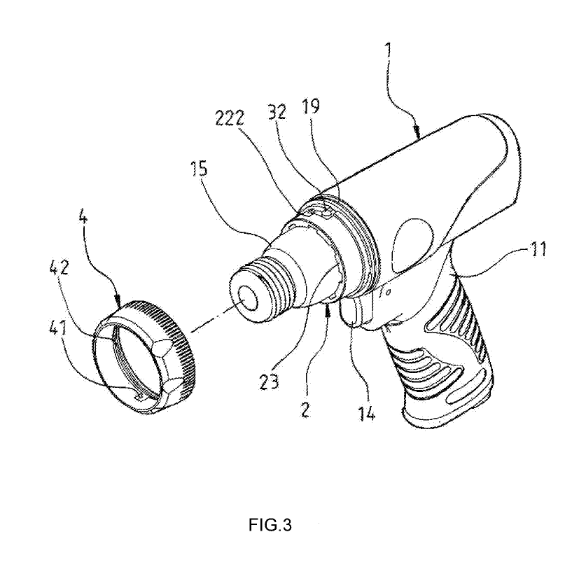

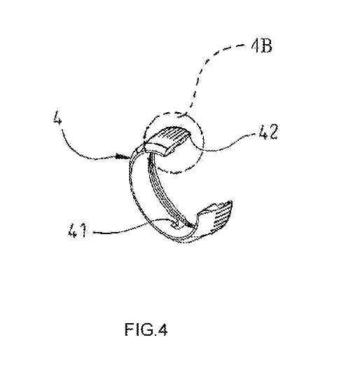

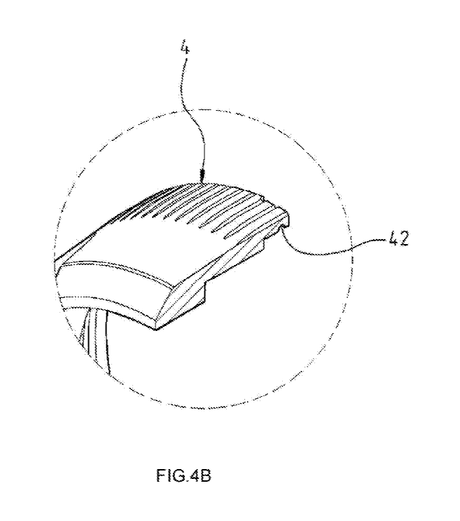

Referring to FIGS. 1 to 4 at a same time, in association with FIG. 2A and FIG. 4B, it shows three-dimensional exploded views, a partial cutaway view of a tool body and a partial cutaway view of an adjustment element, according to the present invention. As shown in the drawings, the present invention comprises primarily a tool body 1 which is provided with a handle 11. A bottom rim of the handle 11 is provided with a cover plate 12, an air inlet 13 and a trigger set 14; whereas, an interior of the tool body 1 is provided with a cylinder 15, a piston 16, a valve seat set 17, an air guide element 2, a brake element 3 and an adjustment element 4. When the present invention is used, a fitting is disposed at a front end of the cylinder 15 to form the cutting or drilling operation by the trigger set 14. An inner rim at a front end of the tool body 1 is provided with at least two rabbets 18, and an outer rim at the front end of the tool body 1 is surrounded by a protruded rib 19.

The air guide element 2 is sheathed at the front end of the tool body 1, and an outer rim of the air guide element 2 is provided with positioning ribs 21 corresponding to the rabbets 18 of the tool body 1, allowing the air guide element 2 to be positioned by latching the positioning ribs 21 into the rabbets 18. The air guide element 2 is provided with a front air guide structure and a rear air guide structure, the rear air guide structure is provided with a cutting groove 22 at a proper location between the positioning ribs 21, and an inner rim at a front end of the front air guide structure is provided with rib parts 23 which are arranged at intervals. In the present embodiment, the L-shaped cutting groove 22 includes a vertical section 221 and a horizontal section 222, and a proper location of the vertical section 221 is provided with a wide enlarged part 223.

The brake element 3 is sheathed at the air guide element 2 and is provided with a front movable guiding structure and a rear movable guiding structure. The rear movable guiding structure is provided with an air guide hole 31, and a proper location at a front end of the air guide hole 31 is provided with a pillar 32. An inner rim at a front end of the front movable guiding structure is provided with shield parts 33 which are arranged at intervals, such that after the brake element 3 has been sheathed at the air guide element 2, the pillar 32 can be just latched into the horizontal section 222 of the cutting groove 22 of the air guide element 2 for positioning.

The adjustment element 4 is in an annular shape, and an inner rim of the adjustment element 4 is provided with a slot 41 corresponding to the pillar 32 of the brake element 3 and is surrounded with a rabbet 42, so that the adjustment element 4 can be latched into the protruded rib 19 of the tool body 1 by the rabbet 42, and can rotate after being positioned. In addition, the pillar 32 can be just latched into the slot 41, so that when the adjustment element 4 rotates, the brake element 3 can be driven to rotate by the restraint of the pillar 32 and the slot 41.

By the combination of the abovementioned components, when the pneumatic tool is used, the air guide hole 31 of the brake element 3 can be superimposed to the cutting groove 22 of the air guide element 2, and the shield parts 33 can shield the interval positions of the rib parts 23 of the air guide element 2 by rotating the adjustment element 4 clockwise or counterclockwise, allowing air to be discharged backward to prevent from suspension of dust to facilitate drilling. Or, the air guide hole 31 of the brake element 3 can escape from the cutting groove 22 of the air guide element 2, and the shield parts 33 can be superimposed to the rib parts 23 of the air guide element 2, allowing debris to be discharged forward to facilitate cutting.

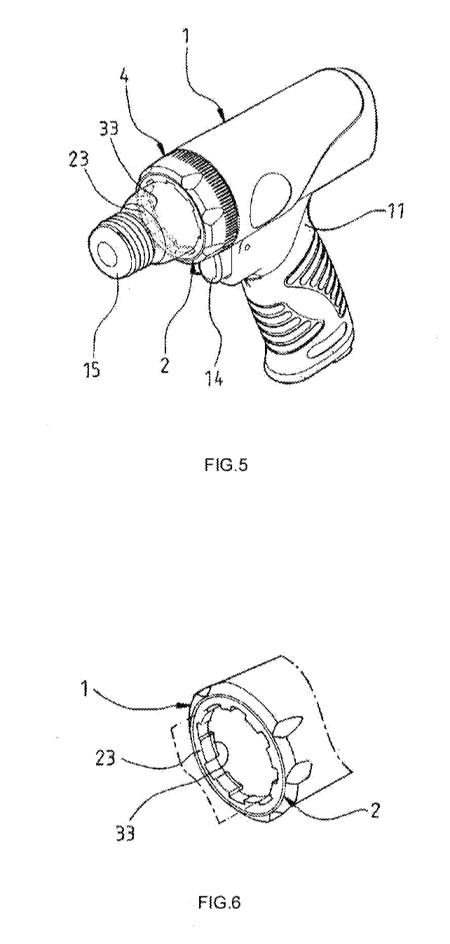

Referring to FIG. 5 and FIG. 6 at a same time, in association with FIG. 9, it shows state diagrams of the shield parts and the rib parts when the present invention discharges air forward, and a state diagram of the air guide hole and the cutting groove when the present invention discharges air forward. As shown in the drawings, when the pneumatic tool of the present invention is used in the cutting operation, the adjustment element 4 rotates counterclockwise, allowing the air guide hole 31 of the brake element 3 to escape from the cutting groove 22 of the air guide element 2 (the air guide hole 31 is not superimposed to the cutting groove 22 but shielded by the air guide element 2), and the shield parts 33 to be superimposed to the rib parts 23 of the air guide element 2. Therefore, plural notches will be formed at the front end of the air guide element 2 (the notches between the rib parts 23), so that debris formed in the cutting operation can be discharged and cleaned forward, thereby facilitating viewing the range of the working subject clearly to improve the efficiency of operation.

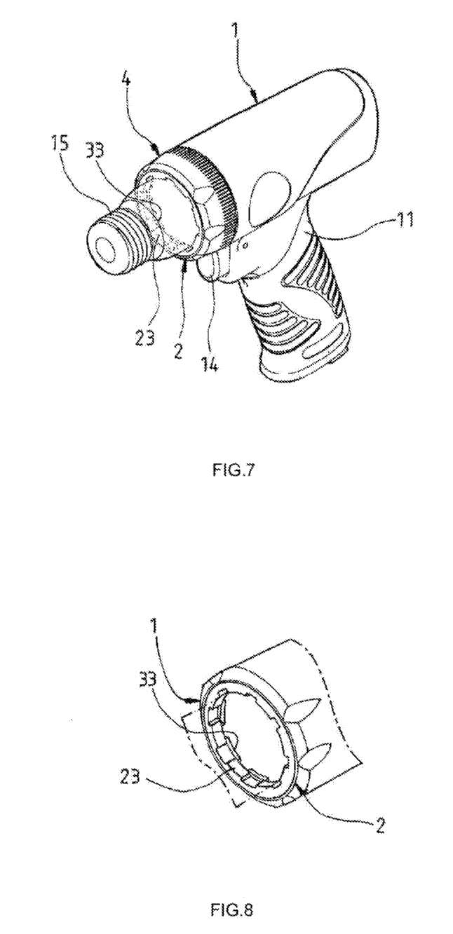

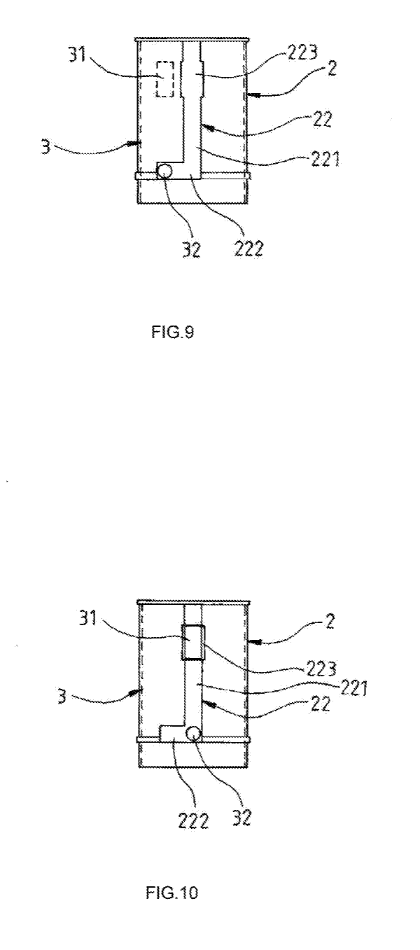

Referring to FIG. 7 and FIG. 8 at a same time, in association with FIG. 10, it shows state diagrams of the shield parts and the rib parts when the present invention discharges air backward, and a state diagram of the air guide hole and the cutting groove when the present invention discharges air backward. As shown in the drawings, when the pneumatic tool of the present invention is used in the drilling operation, the adjustment element 4 rotates clockwise to allow the air guide hole 31 of the brake element 3 to be superimposed to the cutting groove 22 of the air guide element 2 (the air guide hole 31 is not shielded by the air guide element 2), and allow the shield parts 33 to be disposed at the intervals between the rib parts 23 of the air guide element 2. Therefore, the front end of the air guide element 2 will be formed in a shielded state by the shield parts 33 and the rib parts 23 (the notches between the rib parts 23 are shielded by the shield parts 33), allowing air formed in the drilling operation to be discharged backward along the handle 11 to prevent from suspension of dust, which facilitates viewing the range of the working subject clearly to improve the efficiency of operation. In the present embodiment, the air guide hole 31 is just located at the enlarged part 223 of the vertical section 221 of the cutting groove 22 to facilitate discharging air backward.

Accordingly, the present invention discloses an air exhaust method of a pneumatic tool and devices thereof by an air guide element having a front and rear air guide structure, a brake element having a front and rear movable guiding structure and an adjustment element driving the brake element, allowing air to be discharged backward to facilitate drilling or allowing debris to be discharged forward to facilitate cutting, simply by adjusting the rotation of the pneumatic tool.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An air exhaust method of a pneumatic tool and devices thereof, comprising a tool body which is provided with an air guide element, a brake element which is sheathed at the air guide element, and an adjustment element which is fixed at the brake element to drive the brake element to rotate; the air guide element being provided with a front and rear air guide structure and the brake element being provided with a front and rear movable guiding structure corresponding to the air guide structures, such that when the pneumatic tool is used, the brake element being driven by clockwise or counterclockwise rotation of the adjustment element, allowing the front and rear movable guiding structure of the brake element to be superimposed to the front and rear air guide structure of the air guide element, so that air is discharged backward to prevent from suspension of dust to facilitate drilling, or allowing the front and rear movable guiding structure to escape from the front and rear air guide structure of the air guide element, so that debris is discharged forward to facilitate cutting.

2. The air exhaust method of a pneumatic tool and devices thereof, according to claim 1, wherein the tool body is provided with rabbets, and an outer rim of the air guide element is provided with positioning ribs corresponding to the rabbets, allowing the air guide element to be latched into the rabbets for positioning by the positioning ribs.

3. The air exhaust method of a pneumatic tool and devices thereof, according to claim 1, wherein the adjustment element is locked on the tool body, and an inner rim of the adjustment element is provided with a slot corresponding to a pillar of the brake element, allowing the pillar to be just latched into the slot, so that when the adjustment element rotates, the brake element is driven to rotate by the restraint of the pillar and the slot.

4. The air exhaust method of a pneumatic tool and devices thereof, according to claim 1, wherein the rear air guide structure of the air guide element is provided at a proper location between the positioning ribs with a cutting groove containing a vertical section and a horizontal section, an inner rim at a front end of the front air guide structure is provided with rib parts arranged at intervals, the rear movable guiding structure of the brake element is provided with an air guide hole, a front end of the air guide hole is provided with a pillar, and an inner rim at a front end of the front movable guiding structure is provided with shield parts arranged at intervals, allowing the pillar to be just latched into the horizontal section of the cutting groove of the air guide element for positioning, so that when the adjustment element drives the brake element to rotate, the air guide hole of the brake element is superimposed to the cutting groove of the air guide element, and the shield parts shield the intervals between the rib parts of the air guide element, or the air guide hole of the brake element escapes from the cutting groove of the air guide element, and the shield parts are superimposed to the rib parts of the air guide element.

5. The air exhaust method of a pneumatic tool and devices thereof, according to claim 2, wherein the rear air guide structure of the air guide element is provided at a proper location between the positioning ribs with a cutting groove containing a vertical section and a horizontal section, an inner rim at a front end of the front air guide structure is provided with rib parts arranged at intervals, the rear movable guiding structure of the brake element is provided with an air guide hole, a front end of the air guide hole is provided with a pillar, and an inner rim at a front end of the front movable guiding structure is provided with shield parts arranged at intervals, allowing the pillar to be just latched into the horizontal section of the cutting groove of the air guide element for positioning, so that when the adjustment element drives the brake element to rotate, the air guide hole of the brake element is superimposed to the cutting groove of the air guide element, and the shield parts shield the intervals between the rib parts of the air guide element, or the air guide hole of the brake element escapes from the cutting groove of the air guide element, and the shield parts are superimposed to the rib parts of the air guide element.

6. The air exhaust method of a pneumatic tool and devices thereof, according to claim 4, wherein L-shaped cutting groove of the air guide element is provided with a vertical section and a horizontal section, allowing the pillar of the brake element to be just latched into the horizontal section of the cutting groove of the air guide element for positioning.

7. The air exhaust method of a pneumatic tool and devices thereof, according to claim 5, wherein L-shaped cutting groove of the air guide element is provided with a vertical section and a horizontal section, allowing the pillar of the brake element to be just latched into the horizontal section of the cutting groove of the air guide element for positioning.

8. The air exhaust method of a pneumatic tool and devices thereof, according to claim 4, wherein the cutting groove of the air guide element is provided with a wide enlarged part, so that when the air guide hole of the brake element is superimposed to the cutting groove of the air guide element, the air guide hole is just disposed at the enlarged part to facilitate discharging air backward.

9. The air exhaust method of a pneumatic tool and devices thereof, according to claim 5, wherein the cutting groove of the air guide element is provided with a wide enlarged part, so that when the air guide hole of the brake element is superimposed to the cutting groove of the air guide element, the air guide hole is just disposed at the enlarged part to facilitate discharging air backward.

10. The air exhaust method of a pneumatic tool and devices thereof, according to claim 1, wherein an outer rim at a front end of the tool body is surrounded with a protruded rib, and an inner rim of the adjustment element is provided with a rabbet, allowing the adjustment element to be latched into the rabbet by the adjustment element to position the adjustment element at the tool body.
